(19) United States
(12) Patent Application Publication
(10) Pub. No.: US 2024/0147382 A1
(43) Pub. Date: May 2, 2024

(54) RADIO UNIT OUTPUT POWER MANAGEMENT

(71) Applicant: DISH Wireless L.L.C., Englewood, CO (US)

(72) Inventors: John Puma, Castle Rock, CO (US); Montgomery Groff, Denver, CO (US); Ross Drennan, Monument, CO (US); Paul Keator, Elizabeth, CO (US); Mark Templeman, Parker, CO (US); Marcel Guajardo, Lakewood, CO (US); Gerard Canavan, Englewood, CO (US); Adam Saenger, Castle Pines, CO (US); Monte Giles, Littleton, CO (US)

(21) Appl. No.: 17/974,333

(22) Filed: Oct. 26, 2022

(51) Int. Cl. H04W 52/26; H04W 28/18

(52) U.S. Cl. CPC H04W 52/265; H04W 28/18

(57) ABSTRACT

Radio unit output power management technologies are disclosed. An example method for managing output power of radio units serving a private communications network includes obtaining network status including output power status of the radio units and spectrum information indicating frequency bands utilized by the one or more radio units, performance requirements of the private communications network, and constraints applicable to output power of the radio units in accordance with the spectrum information. The method also includes determining a dynamically-optimized output power strategy for the one or more radio units to satisfy the performance requirements based on the output power status and spectrum information, subject to the constraints, and implementing particularized radio unit output power control based on the output power strategy.

### BACKGROUND

In telecommunications, 5G is the fifth-generation technology standard for broadband cellular networks. 5G networks are cellular networks, in which the service area is divided into small geographical areas called cells. 5G wireless devices in a cell can communicate by radio waves with a cellular base station (e.g., access point or other radio unit) via fixed antennas, over frequency channels assigned by the base station. The base stations can be connected to switching centers in the telephone network and routers for Internet access by high-bandwidth optical fiber or wireless backhaul connections. In particular, small cells are low-powered cellular radio access nodes that operate in licensed and unlicensed spectrum that typically have a range of 10 meters to a few kilometers.

5G can be implemented in low-band, mid-band or high-band millimeter-wave 24 GHz up to 54 GHz. Beyond mobile operator networks, 5G can also be used for private networks with applications in industrial IoT, enterprise networking, and critical communications. Large quantities of new radio spectrum (5G NR frequency bands) have been allocated to 5G. For example, the U.S. Federal Communications Commission (FCC) freed up vast amounts of bandwidth in underused high-band spectrum for 5G. The Spectrum Frontiers Proposal (SFP) doubled the amount of millimeter-wave unlicensed spectrum to 14 GHz. Many countries and regions have announced plans to auction frequencies or have already allocated spectrum for 5G use.

### BRIEF SUMMARY

A private wireless network can provide wireless broadband connectivity, similar to a public wireless network (e.g., a mobile operator network), but is owned or controlled by an entity that built it or otherwise acquired it. A private network can use spectrum that is leased from a carrier or from another spectrum owner, use unlicensed spectrum such as the general authorized access (GAA) tier of the Citizens Broadband Radio Service (CBRS) band, or run on licensed spectrum, such as CBRS priority access licenses (PALs) via FCC auctions, that is owned by the entity that is building the private network.

The different spectrums a private network can utilize may be associated with varied rules of operation or other constraints that require associated radio units adhere to different output power limits. For example, a private network small cell radio unit (e.g., access point) can utilize a combination of mid-band spectrum bands n77 and n48, as well as Wi-Fi bands, each associated with different output power constraints.

Thus, there is a need for efficient and adaptive radio unit output power management technologies. In accordance with some embodiments, a computer-implemented method for managing output power of one or more radio units serving a private communications network is provided. The method includes obtaining, by an output power management device, (a) network status including output power status of the one or more radio units and spectrum information indicating a plurality of frequency bands utilized by the one or more radio units, (b) performance requirements of the private communications network, and (c) one or more constraints applicable to output power of the one or more radio units, in accordance with the spectrum information. The method further includes determining, by the output power management device, a dynamically-optimized output power strategy for the one or more radio units to satisfy the performance requirements based, at least in part, on the output power status and spectrum information, subject to the one or more constraints, and implementing particularized radio unit output power control based, at least in part, on the output power strategy.

In some embodiments, the performance requirements include one or more estimated or anticipated requirements. In some embodiments, the one or more estimates or anticipated requirements include at least one of network payload, use case requirements, or quality of service (QoS) requirements. In some embodiments, the obtaining of the network status and spectrum information is performed in real-time.

In some embodiments, the plurality of frequency bands include one or more licensed frequency bands and one or more unlicensed frequency bands. In some embodiments, the one or more licensed frequency bands include at least one of Citizens Band Radio Service (CBRS) Band n48 or New Radio (NR) Band n77. In some embodiments, the one or more unlicensed frequency bands include one or more Wi-Fi frequency bands.

In some embodiments, the one or more radio units include at least one access point device capable of wirelessly communicating in one or more licensed frequency bands and one or more unlicensed frequency bands. In some embodiments, the determining of the output power strategy is further based on an optimization to minimize overall output power of the one or more radio units. In some embodiments, the method further includes receiving, from a spectrum management device, updated spectrum information indicating another plurality of frequency bands to be utilized by the one or more radio units, and determining the output power strategy based further on the updated spectrum information.

In some embodiments, a radio unit output power management device for a private communications network includes at least one memory that stores computer executable instructions and at least one processor that executes the computer executable instructions to cause actions to be performed. The actions include obtaining network status including output power status of one or more radio units and spectrum information indicating a plurality of frequency bands utilized by the one or more radio units, obtaining performance requirements of the private communications network, determining a dynamically-optimized output power strategy for the one or more radio units to satisfy the performance requirements based, at least in part, on the output power status and spectrum information, subject to the one or more constraints applicable to output power of the one or more radio units in accordance with the spectrum information, and implementing particularized radio unit output power control based, at least in part, on the output power strategy.

In some embodiments, the performance requirements include one or more estimated or anticipated requirements. In some embodiments, the plurality of frequency bands include one or more licensed frequency bands and one or more unlicensed frequency bands. In some embodiments, the one or more licensed frequency bands include at least one of Citizens Band Radio Service (CBRS) Band n48 or New Radio (NR) Band n77. In some embodiments, the one or more unlicensed frequency bands include one or more Wi-Fi frequency bands.

In some embodiments, the determining of the output power strategy is further based on an optimization to minimize overall output power of the one or more radio units. In some embodiments, the actions further include receiving, from a spectrum management device, updated spectrum information indicating another plurality of frequency bands to be utilized by the one or more radio units, and determining the output power strategy based further on the updated spectrum information.

In some embodiments, a non-transitory computer-readable medium stores contents that, when executed by one or more processors, cause the one or more processors to perform actions. The actions include obtaining network status including output power status of one or more radio units and spectrum information indicating a plurality of frequency bands utilized by the one or more radio units, obtaining performance requirements of a private communications network, determining a dynamically-optimized output power strategy for the one or more radio units to satisfy the performance requirements based, at least in part, on the output power status and spectrum information, subject to the one or more constraints applicable to output power of the one or more radio units in accordance with the spectrum information, and implementing particularized radio unit output power control based, at least in part, on the output power strategy.

In some embodiments, the plurality of frequency bands include one or more licensed frequency bands and one or more unlicensed frequency bands. In some embodiments, the spectrum information is received from an external device different from the one or more radio units.

### BRIEF DESCRIPTION OF THE DRAWINGS

FIG. 1 is a block diagram illustrating an example networked environment for facilitating the management of radio unit output power in accordance with some embodiments of the techniques described herein.

FIG. 2 depicts an example of mid-band spectrums and associated differences in allowable output power, in accordance with some embodiments of the techniques described herein.

FIG. 3 is a flow diagram depicting an example process for managing radio unit output power in accordance with some embodiments of the techniques described herein.

FIG. 4 is a block diagram illustrating elements of an example computing device utilized in accordance with some embodiments of the techniques described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the environment, have not been shown or described in order to avoid unnecessarily obscuring descriptions of the embodiments. Additionally, the various embodiments may be methods, systems, media, or devices. Accordingly, the various embodiments may combine software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

References to the term “set” (e.g., “a set of items”), as used herein, unless otherwise noted or contradicted by context, is to be construed as a nonempty collection comprising one or more members or instances.

References to the term “subset” (e.g., “a subset of the set of items”), as used herein, unless otherwise noted or contradicted by context, is to be construed as a nonempty collection comprising one or more members or instances of a set or plurality of members or instances.

Moreover, the term “subset,” as used herein, refers to a proper subset, which is a collection of one or more members or instances that are collectively smaller in number than the set or plurality of which the subset is drawn. For instance, a subset of a set of ten items will have less than ten items and at least one item.

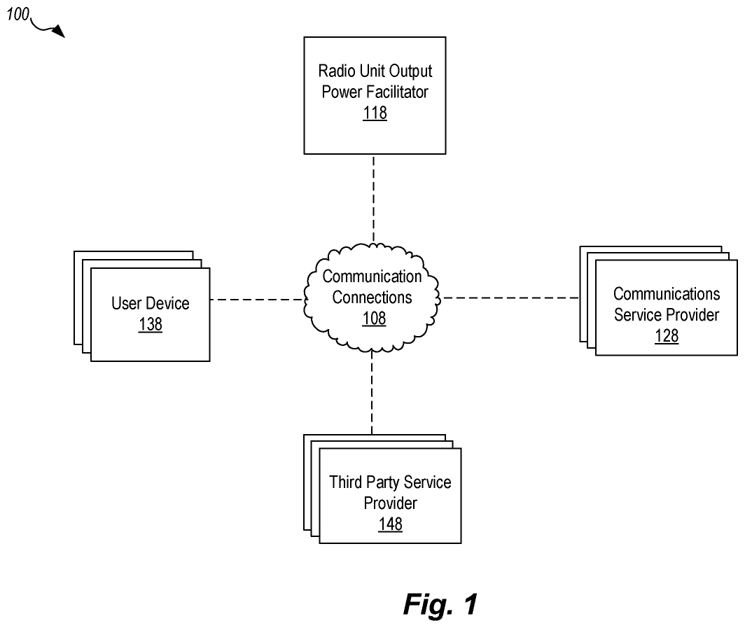

FIG. 1 is a block diagram illustrating an example networked environment 100 for facilitating the management of radio unit output power in accordance with some embodiments of the techniques described herein. The networked environment 100 includes a radio unit output power facilitator 118, one or more communications service providers (CSPs) 128, one or more user devices 138, and one or more third party service providers 148. A user device 138 can be connected to a telephone network, Internet, or other communications network via at least some part of communication connections 108, which are at least partially subject to control by one or more of the CSP(s) 128. The CSPs 128 can include, for example, a private wireless network operating a set of radio units capable of utilizing different spectrums, and in some embodiments, also include one or more other mobile network operators facilitated by the private wireless network.

In the depicted networked environment 100, the communication connections 108 may comprise one or more computer networks, one or more wired or wireless networks, satellite transmission media, one or more cellular networks, or some combination thereof. The communication connections 108 may include a publicly accessible network of linked networks, possibly operated by various distinct parties, such as the Internet. The communication connections 108 may include other network types, such as one or more private networks (e.g., corporate or university networks that are wholly or partially inaccessible to non-privileged users), and may include combinations thereof, such that (for example) one or more of the private networks have access to and/or from one or more of the public networks. Furthermore, the communication connections 108 may include various types of wired and/or wireless networks in various situations, including satellite transmission. In addition, the communication connections 108 may include one or more communication interfaces to individual entities in the networked environment 100, various other mobile devices, computing devices and media devices, including but not limited to, radio frequency (RF) transceivers, cellular communication interfaces and antennas (e.g., CBRS nodes or other wireless nodes), USB interfaces, ports and connections (e.g., USB Type-A, USB Type-B, USB Type-C (or USB-C), USB mini A, USB mini B, USB micro A, USB micro C), other RF transceivers (e.g., infrared transceivers, Zigbee® network connection interfaces based on the IEEE 802.15.4 specification, Z-Wave® connection interfaces, wireless Ethernet (“Wi-Fi”) interfaces, short range wireless (e.g., Bluetooth®) interfaces and the like).

In various embodiments, examples of a user device 138 include, but are not limited to, one or a combination of the following: a “computer,” “mobile device,” “gaming console,” “tablet computer,” “smart phone,” “handheld computer,” and/or “workstation,” etc. The user device(s) 138 may be any suitable computing device or electronic equipment that, e.g., can be connected wirelessly to the CSP(s) 128 via one or more radio units.

In various embodiments, the radio unit output power facilitator 118 can include one or more computing devices for performing the radio unit output power management functions described herein. Illustratively, the radio unit output power facilitator 118 can be part of an access point or other radio unit that is transmitting data to the user device, or can be a separate server that communicates and instructs the radio unit(s) of output power control. The radio unit output power facilitator 118 can include functional units that control, leverage, other otherwise facilitate the use of both licensed spectrum (e.g., n77 and n48) and unlicensed spectrum (e.g., Wi-Fi). For example, in licensed spectrum, if n77 and n48 are channel aggregated for a specific service in the private network, the radio unit power is limited to n48 Output Power Limits (Indoor Radio Unit Equivalent Isotropic Radiated Power (RU EIRP): 30 dBm, and Outdoor RU EIRP: 47 dBm, for corresponding 10 MHz channels or blocks) in accordance with FCC Part 96.

However, if the private network only utilizes n77, then a higher power limit (Any RU EIRP: 65 dBm (for rural areas, else 62 dBm for urban)) is allowed based on Other spectrum (n77) Output Power Limits.

Various other combinations of spectrum bands (i.e., n48+n71) can be used by the private network, including newer 5G spectrum bands through future spectrum actions. In addition, Wi-Fi can be used by the private network, and the operations in the 2.4, 5, and 6 GHz bands are subject to different power output constraints (Indoor: 23 dBm, and Outdoor: 30-36 dBm). The radio unit output power facilitator 118 can take into account all power limits of all spectrums being utilized to the select the appropriate power settings.

Accordingly, for a customer of the private wireless network, the radio unit output power facilitator 118 can manage output power operation when any combination of spectrum is associated with different and varied output power constraints, while also delivering to meet customer network performance needs. In some embodiments, the radio unit output power facilitator 118 is part of a CSP 128 (e.g., an element in the core network of a private wireless service provider).

In various embodiments, individual CSPs 128 and third party service providers 148 can be implemented in software and/or hardware form on one or more computing devices including a “computer,” “mobile device,” “tablet computer,” “smart phone,” “handheld computer,” “server,” and/or “workstation,” etc. The CSP(s) 128 or third party service provider(s) 148 can provide information or services to the radio unit output power facilitator 118, to further facilitate the management of radio unit output power. As an example, an output power constraint service or device can provide constraint information including regulatory output power allowance for classifications of radio unit (e.g., FCC Part 96, 3GPP), regulatory output power allowance for radio unit type (e.g., indoor type, outdoor type), industrial standards or best practices, or the like. As another example, a spectrum management service or device can allocate or grant additional or updated set of licensed or unlicensed spectrum for radio unit(s) to use. As a further example, particular spectrum access system(s) or service(s) may be required to assign allowable output power to radio unit(s). As still another example, a channel aggregation service or device can identify and select channel aggregation combos of spectrum, e.g., in accordance with regulations, industrial standards, or other rules.

Data communications among entities of the networked environment 100 can be encrypted. Related encryption and decryption may be performed as applicable according to one or more of any number of currently available or subsequently developed encryption methods, processes, standards, protocols, and/or algorithms, including but not limited to: encryption processes utilizing a public-key infrastructure (PKI), encryption processes utilizing digital certificates, the Data Encryption Standard (DES), the Advanced Encryption Standard (AES 128, AES 192, AES 256, etc.), the Common Scrambling Algorithm (CSA), encryption algorithms supporting Transport Layer Security 1.0, 1.1, and/or 1.2, encryption algorithms supporting the Extended Validation (EV) Certificate, etc.

The above description of the exemplary networked environment 100 and the various service providers, systems, networks, and devices therein is intended as a broad, non-limiting overview of an example environment in which various embodiments of the presently disclosed technologies may be implemented. FIG. 1 illustrates just one example of an operating environment, and the various embodiments discussed herein are not limited to such an environment. In particular, the networked environment 100 may contain other devices, systems, or media not specifically described herein.

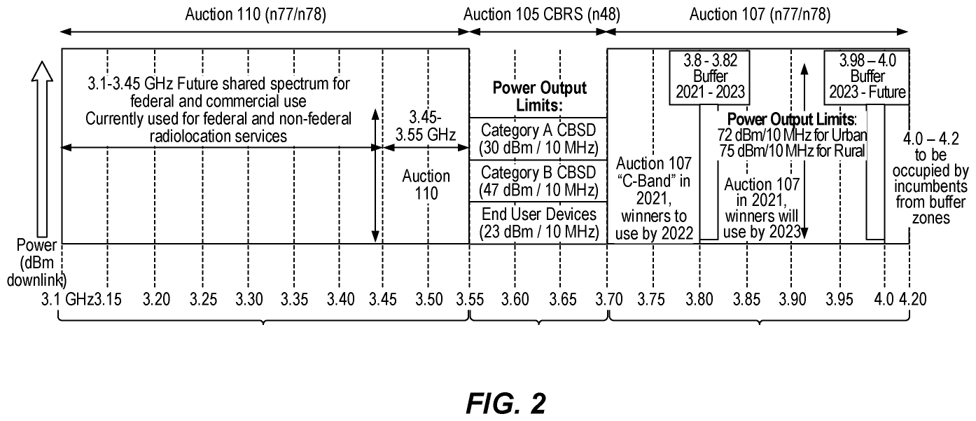

FIG. 2 depicts an example of mid-band spectrums and associated differences in allowable output power, in accordance with some embodiments of the techniques described herein.

As shown, FCC Auction 110 (n77/n78 bands) includes 3.45-3.55 GHz spectrum repurposed and offered in 10 MHz blocks, which are licensed; Auction 110 also includes additional spectrum in the 3.1-3.45 GHz range for future use.

FCC Auction 105 (CBRS n48 bands) includes 3.55-3.7 GHz spectrum repurposed and offered in 10 MHz blocks, and the spectrum is shared among 3 Tier priority groups. In particular, a spectrum access system service is required to operate on the spectrum. According to the 3 Tier priorities, Tier 1 is incumbent users that can use 3.55-3.70 GHz spectrum, Tier 2 is priority access license (PAL) users that can use 3.55-3.65 GHz spectrum, and Tier 3 is general authorized access (unlicensed) users that can use 3.55-3.70 GHz spectrum.

FCC Auction 107 (n77/n78 bands) includes “C-Band” spectrum repurposed and offered in 20 MHz blocks. As can be seen from FIG. 2, the power output limits vary between n77/n78 bands and n48 bands, and also vary among different categories of CBRS (n48) devices. In some embodiments, at least these different constraints are used by the radio unit output power facilitator 118 to manage radio unit output power for a private wireless network.

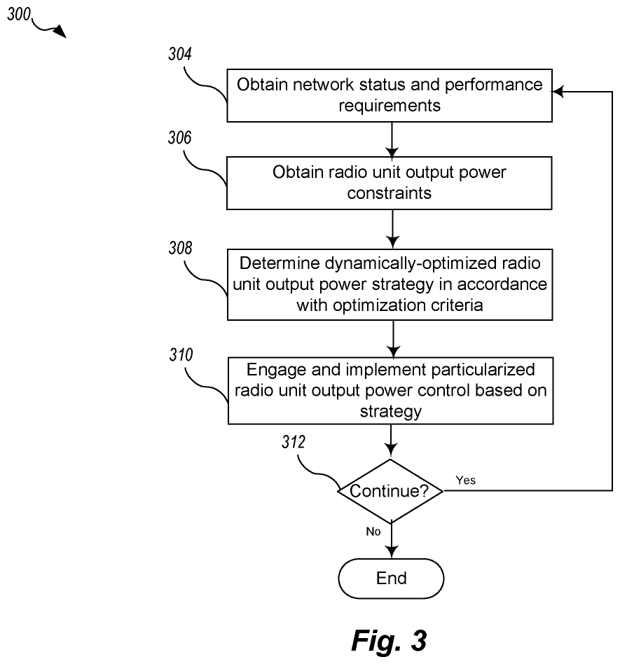

FIG. 3 is a flow diagram depicting an example process for managing radio unit output power in accordance with some embodiments of the techniques described herein. In various embodiments, the process 300 is performed in real time, and at least some part of the process 300 is performed in a transparent manner to a user of the user device. Illustratively, at least some part of the process 300 can be implemented by the radio unit output power facilitator 118 of FIG. 1.

The process 300 starts at block 304, which includes obtaining network status of a private wireless network that utilizes one or more radio units, as well as performance requirements of the private wireless network. The network status can include current or historical output power status of the one or more radio units and spectrum information indicating frequency bands currently utilized or usable by the one or more radio units. The frequency bands can include one or more licensed frequency bands (e.g., CBRS Band n48 or NR Band n77) and one or more unlicensed frequency bands (e.g., Wi-Fi frequency bands). The performance requirements can include one or more current, estimated, or anticipated requirements, such as network payload, use case requirements, or quality of service (QoS) requirements.

At block 306, the process 300 includes obtaining one or more constraints applicable to output power of the one or more radio units. The constraints can be obtained in accordance with the spectrum information, as they may vary for different spectrums. As described above, the constraints can indicate output power limits or requirements of the different spectrums, and the constraints may be government rules and regulations, industrial standards or best practices, organizational or private requirements, physical limitations, combination of the same or the like.

At block 308, the process 300 includes determining a dynamically-optimized output power strategy for the one or more radio units to satisfy the performance requirements based on the network status and spectrum information, subject to the one or more constraints. The strategy can be computed or otherwise determined using applicable linear or non-linear optimization techniques based on one or more criteria, e.g., to minimize an overall output power of the one or more radio units, to minimize an anticipated quantity of output power changes within a period of time, to minimize output power distribution differences among the one or more radio units, or the like. In some embodiments, the process 300 includes receiving updated spectrum information indicating other frequency bands to be utilized or usable by the one or more radio units, and the determining the output power strategy can be based further on the updated spectrum information.

At block 310, the process 300 includes engaging and implementing particularized radio unit output power control based on the output power strategy. Due to the different constraints and requirements of different spectrums, the implementation of output power control for radio units may need to involve particularized internal or external systems or services, e.g., to specifically manage n48 output power, n77 output power, Wi-Fi output power, combination of the same or the like. If certain spectrum(s) is not used by a radio unit, the corresponding particularized control does not need to be engaged, which saves computational or communication resources.

At block 312, the process 300 includes determining whether to continue the process. If so, the process proceeds to block 304; otherwise, the process ends.

The various operations depicted via FIG. 3, as well as those described elsewhere herein, may be altered in a variety of ways. For example, the particular order of the operations may be rearranged; some operations may be performed in parallel; shown operations may be omitted, or other operations may be included; a shown operation may be divided into one or more component operations, or multiple shown operations may be combined into a single operation, etc.

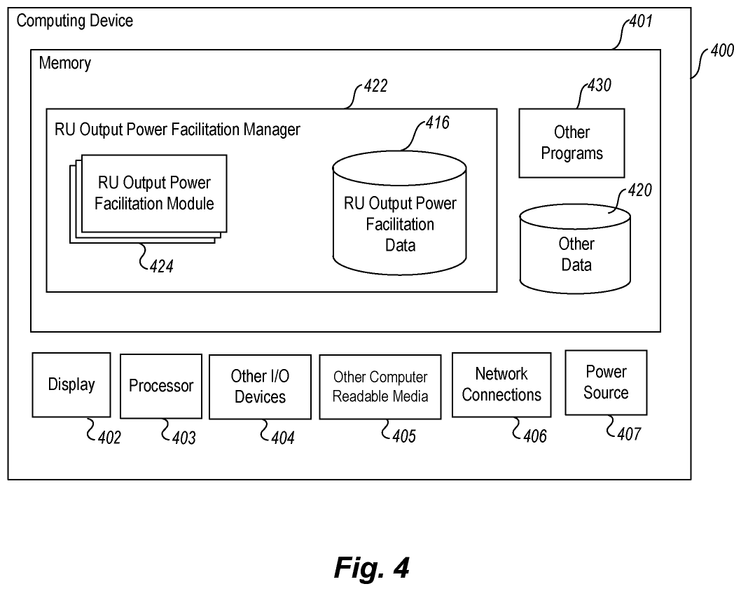

FIG. 4 is a block diagram illustrating elements of an example computing device 400 utilized in accordance with some embodiments of the techniques described herein. Illustratively, the computing device 400 corresponds to an RU output power facilitator 118, a CSP 128, a user device 138, or at least a part thereof.

In some embodiments, one or more general purpose or special purpose computing systems or devices may be used to implement the computing device 400. In addition, in some embodiments, the computing device 400 may comprise one or more distinct computing systems or devices, and may span distributed locations. Furthermore, each block shown in FIG. 4 may represent one or more such blocks as appropriate to a specific embodiment or may be combined with other blocks. Also, the RU output power facilitation manager 422 may be implemented in software, hardware, firmware, or in some combination to achieve the capabilities described herein.

As shown, the computing device 400 comprises a computer memory (“memory”) 401, a display 402 (including, but not limited to a light emitting diode (LED) panel, cathode ray tube (CRT) display, liquid crystal display (LCD), touch screen display, projector, etc.), one or more Central Processing Units (CPU) or other processors 403, Input/Output (I/O) devices 404 (e.g., keyboard, mouse, RF or infrared receiver, universal serial bus (USB) ports, High-Definition Multimedia Interface (HDMI) ports, other communication ports, and the like), other computer-readable media 405, network connections 406, a power source (or interface to a power source) 407. The RU output power facilitation manager 422 is shown residing in memory 401. In other embodiments, some portion of the contents and some, or all, of the components of the RU output power facilitation manager 422 may be stored on and/or transmitted over the other computer-readable media 405. The components of the computing device 400 and c RU output power facilitation manager 422 can execute on one or more processors 403 and implement applicable functions described herein. In some embodiments, the RU output power facilitation manager 422 may operate as, be part of, or work in conjunction and/or cooperation with other software applications stored in memory 401 or on various other computing devices. In some embodiments, the RU output power facilitation manager 422 also facilitates communication with peripheral devices via the I/O devices 404, or with another device or system via the network connections 406.

The one or more RU output power facilitation modules 424 is configured to perform actions related, directly or indirectly, to facilitating and managing output power for radio units as described herein. In some embodiments, the RU output power facilitation module(s) 424 stores, retrieves, or otherwise accesses at least some RU output power facilitation-related data on some portion of the RU output power facilitation data storage 416 or other data storage internal or external to the computing device 400. In various embodiments, at least some of the RU output power facilitation modules 424 may be implemented in software or hardware.

Other code or programs 430 (e.g., further data processing modules, communication modules, a Web server, and the like), and potentially other data repositories, such as data repository 420 for storing other data, may also reside in the memory 401, and can execute on one or more processors 403. Of note, one or more of the components in FIG. 4 may or may not be present in any specific implementation. For example, some embodiments may not provide other computer readable media 405 or a display 402.

In some embodiments, the computing device 400 and RU output power facilitation manager 422 include API(s) that provides programmatic access to add, remove, or change one or more functions of the computing device 400. In some embodiments, components/modules of the computing device 400 and RU output power facilitation manager 422 are implemented using standard programming techniques. For example, the RU output power facilitation manager 422 may be implemented as an executable running on the processor(s) 403, along with one or more static or dynamic libraries. In other embodiments, the computing device 400 and RU output power facilitation manager 422 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C #, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), or declarative (e.g., SQL, Prolog, and the like).

In a software or firmware implementation, instructions stored in a memory configure, when executed, one or more processors of the computing device 400 to perform the functions of the RU output power facilitation manager 422. In some embodiments, instructions cause the one or more processors 403 or some other processor(s), such as an I/O controller/processor, to perform at least some functions described herein.

The embodiments described above may also use well-known or other synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs or other processors. Some embodiments may execute concurrently and asynchronously, and communicate using message passing techniques. Equivalent synchronous embodiments are also supported by a RU output power facilitation manager 422 implementation. Also, other functions could be implemented and/or performed by each component/module, and in different orders, and by different components/modules, yet still achieve the functions of the computing device 400 and RU output power facilitation manager 422.

In addition, programming interfaces to the data stored as part of the computing device 400 and RU output power facilitation manager 422, can be available by standard mechanisms such as through C, C++, C #, and Java APIs; libraries for accessing files, databases, or other data repositories; scripting languages such as XML; or Web servers, FTP servers, NFS file servers, or other types of servers providing access to stored data. The RU output power facilitation data storage 416 and data repository 420 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, and Web Services (XML-RPC, JAX-RPC, SOAP, and the like). Other variations are possible. Other functionality could also be provided by each component/module, or existing functionality could be distributed amongst the components/modules in different ways, yet still achieve the functions of the RU output power facilitation manager 422.

Furthermore, in some embodiments, some or all of the components of the computing device 400 and RU output power facilitation manager 422 may be implemented or provided in other manners, such as at least partially in firmware and/or hardware, including, but not limited to one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network, cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use, or provide the contents to perform, at least some of the described techniques.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method for managing output power of one or more radio units serving a private communications network, the method comprising:
obtaining, by an output power management device, network status including output power status of the one or more radio units and spectrum information indicating a plurality of frequency bands utilized by the one or more radio units;
obtaining, by the output power management device, performance requirements of the private communications network;
obtaining, by the output power management device, one or more constraints applicable to output power of the one or more radio units, in accordance with the spectrum information, wherein a constraint for a first frequency band of the plurality of frequency bands indicates an output power limit different than a constraint for a second frequency band of the plurality of frequency bands;
determining, by the output power management device, a dynamically-optimized output power strategy for the one or more radio units to satisfy the performance requirements based, at least in part, on the output power status and the spectrum information, subject to the one or more constraints; and
implementing particularized radio unit output power control based, at least in part, on the output power strategy.

2. The method of claim 1, wherein the performance requirements include one or more estimated or anticipated network requirements.

3. The method of claim 2, wherein the one or more estimated or anticipated network requirements include at least one of network payload, use case requirements, or quality of service (QoS) requirements.

4. The method of claim 1, wherein the obtaining of the network status and spectrum information is performed in real-time.

5. The method of claim 1, wherein the plurality of frequency bands include one or more licensed frequency bands and one or more unlicensed frequency bands.

6. The method of claim 5, wherein the one or more licensed frequency bands include at least one of Citizens Band Radio Service (CBRS) Band n48 or New Radio (NR) Band n77.

7. The method of claim 5, wherein the one or more unlicensed frequency bands include one or more Wi-Fi frequency bands.

8. The method of claim 1, wherein the one or more radio units include at least one access point device capable of wirelessly communicating in one or more licensed frequency bands and one or more unlicensed frequency bands.

9. The method of claim 1, wherein the determining of the output power strategy is further based on an optimization to minimize overall output power of the one or more radio units.

10. The method of claim 1, further comprising:
receiving, from a spectrum management device, updated spectrum information indicating another plurality of frequency bands to be utilized by the one or more radio units; and
determining the output power strategy based further on the updated spectrum information.

11. A radio unit output power management device for a private communications network, the radio unit output power management device comprising:
at least one memory that stores computer executable instructions; and
at least one processor that executes the computer executable instructions to cause actions to be performed, the actions including:
obtaining network status including output power status of one or more radio units and spectrum information indicating a plurality of frequency bands utilized by the one or more radio units;
obtaining performance requirements of the private communications network;
determining a dynamically-optimized output power strategy for the one or more radio units to satisfy the performance requirements based, at least in part, on the output power status and spectrum information, subject to the one or more constraints applicable to output power of the one or more radio units in accordance with the spectrum information; and
implementing particularized radio unit output power control based, at least in part, on the output power strategy.

12. The radio unit output power management device of claim 11, wherein the performance requirements include one or more estimated or anticipated requirements.

13. The radio unit output power management device of claim 11, wherein the plurality of frequency bands include one or more licensed frequency bands and one or more unlicensed frequency bands.

14. The radio unit output power management device of claim 13, wherein the one or more licensed frequency bands include at least one of Citizens Band Radio Service (CBRS) Band n48 or New Radio (NR) Band n77.

15. The radio unit output power management device of claim 13, wherein the one or more unlicensed frequency bands include one or more Wi-Fi frequency bands.

16. The radio unit output power management device of claim 11, wherein the determining of the output power strategy is further based on an optimization to minimize overall output power of the one or more radio units.

17. The radio unit output power management device of claim 11, wherein the actions further include:
receiving, from a spectrum management device, updated spectrum information indicating another plurality of frequency bands to be utilized by the one or more radio units; and
determining the output power strategy based further on the updated spectrum information.

18. A non-transitory computer-readable medium storing contents that, when executed by one or more processors, cause the one or more processors to perform actions comprising:
obtaining network status including output power status of one or more radio units and spectrum information indicating a plurality of frequency bands utilized by the one or more radio units;
obtaining performance requirements of a communications network;
determining a dynamically-optimized output power strategy for the one or more radio units to satisfy the performance requirements based, at least in part, on the output power status and spectrum information, subject to the one or more constraints applicable to output power of the one or more radio units in accordance with the spectrum information; and
implementing particularized radio unit output power control based, at least in part, on the output power strategy.

19. The computer-readable medium of claim 18, wherein the plurality of frequency bands include one or more licensed frequency bands and one or more unlicensed frequency bands.

20. The computer-readable medium of claim 18, wherein the spectrum information is received from an external device different from the one or more radio units.
